(19) United States
(12) Patent Application Publication
(10) Pub. No.: US 2009/0091640 A1
(43) Pub. Date: Apr. 9, 2009

(54) Digital camera with special effect viewfinder, image displaying method on the viewfinder, and photographing method with the digital camera

(75) Inventors: Kyung-min Kim, Seongnam-si (KR); Jong-hwan Lee, Seongnam-si (KR); Kyung-dong Yang, Seongnam-si (KR); Soo-jin Park, Seongnam-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/284,641

(22) Filed: Sep. 24, 2008

(30) Foreign Application Priority Data
Oct. 9, 2007 (KR) 10-2007-0101572

(51) Int. Cl. H04N 5/262

(52) U.S. Cl. 348/239; 348/E05.051

(57) ABSTRACT

A digital camera with a viewfinder, an image displaying method on the viewfinder, and a photographing method with the digital camera are provided. The digital camera includes: a lens unit receiving the image light of an object and forming an image; a photoelectric conversion device converting the formed image into an electrical signal; a viewfinder changing the path of the light passing through the lens unit so that a user can observe the object; a special effect unit disposed in the path of light of the viewfinder and producing a special effect on an image to be displayed on the viewfinder; and a control unit connected to the photoelectric conversion device and the special effect unit and driving the special effect unit according to a selected special effect mode.

### CROSS-REFERENCE TO RELATED PATENT APPLICATIONS

This application claims the benefit of Korean Patent Application No. 10-2007-0101572, filed on Oct. 9, 2007, in the Korean Intellectual Property Office, the disclosure of which is incorporated herein in its entirety by reference.

### BACKGROUND OF THE INVENTION

1. Field of the Invention

The present invention relates to a digital camera, and more particularly, to a digital camera with a viewfinder in which a special effect unit is disposed in the path of light of the viewfinder which produces a special effect on the image of an object. When a picture is taken using a special effect photographing function, the user can confirm in advance an image of an object to be processed by the special effect through the viewfinder, and an image displaying method on the viewfinder, and a photographing method using the digital camera.

2. Description of the Related Art

In general, a digital camera is an apparatus that converts light reflected by an object into an electrical signal, stores the electrical signal as image data, and processes or reproduces the stored image data.

A digital camera enables an image of the object to be directly viewed without a need to perform complicated film development required in conventional film cameras, and thanks to the advantages of easier editing and processing the image using digital media, digital cameras have rapidly been replacing film cameras.

In a digital camera, an optical viewfinder is disposed so that when taking a photograph, a user can adjust the composition by viewing an object. Since the viewfinder directly transfers to the user the image light of the object incoming into the camera lens unit, the user can observe the actual color of the object to be photographed through the viewfinder.

Among functions widely used in ordinary digital cameras, there is a function for producing special effects in an image.

The special effects typically include a monochrome mode, a sepia mode, a user-specified mode, and a color reproduction mode with respect to light sources (fluorescent light, cloudy, sunlight, incandescent lamp). The user selects a desired special effect according to his or her preference or a photographing situation, and takes a photo, thereby obtaining an image which is processed by a desired special effect.

However, a user who takes a photograph by using a conventional digital camera having an optical viewfinder observes an object through the viewfinder which transfers the image light of the object without change, and therefore even when the digital camera is set to perform a special effect photographing function, the user cannot know accurately how the special effect changes the image to be taken.

A user who has little experience using special effect functions can only guess the result of a special effect from the name of each mode displayed on a special effect setting menu of the digital camera or from an instruction manual. Even an experienced user cannot accurately know how the image of the object currently viewed through the viewfinder will be changed by a selected special effect.

Accordingly, when a user takes a photograph using a special effect function, the user can view the result of the special effect only through the resulting photo image which is stored after being taken.

Using a conventional digital camera, only after learning special effect functions through trial and error, the user can appropriately select a special effect to take a photo. Thus, a conventional digital camera has such a problem in relation to special effect photographing functions.

### SUMMARY OF THE INVENTION

The present invention provides a method of enabling a user to view through a viewfinder an image of an object to be obtained through special effect processing before taking a photograph with a digital camera having a special effect photographing function.

The present invention also provides a digital camera having a viewfinder capable of converting an image light in the same manner as the special effect preset in the digital camera.

The present invention also provides a method of displaying an image on a viewfinder disposed in a digital camera.

The present invention also provides a method of photographing with a digital camera.

The present invention provides a digital camera having a special effect unit disposed in the path of light of a viewfinder which produces a special effect on an image of an object, a method of displaying an image on a viewfinder of a digital camera, and a method of photographing with a digital camera.

According to an aspect of the present invention, there is provided a digital camera including: a lens unit receiving the image light of an object and forming an image; a photoelectric conversion device converting the formed image into an electrical signal; a viewfinder changing the path of the light passing through the lens unit so that a user can observe the object; a special effect unit disposed in the path of light of the viewfinder and producing a special effect on an image to be displayed on the viewfinder; and a control unit connected to the photoelectric conversion device and the special effect unit and driving the special effect unit according to a special effect mode selected in advance.

The special effect unit may change one or more of the color, brightness, and saturation of the image to be displayed on the viewfinder.

The viewfinder may include: a mirror disposed in the light path of the lens unit and which changes the path of an image light; a focus screen adjusting the focus of the image light changed by the mirror; a prism changing the path of the image light passing through the focus screen; and an eyepiece receiving the image light emitted from the prism and transferring the image light to a user.

The special effect unit may be disposed so as to be adjacent to the focus screen.

The special effect unit may be disposed so as to be adjacent to the eyepiece.

The special effect unit can be switched between a blocking position for blocking the light path of the viewfinder and an opening position for opening the light path of the viewfinder according to a signal of the control unit.

The special effect unit may be a liquid crystal display (LCD) module,

an organic electroluminescence device, or

a light emitting diode (LED) display device.

The special effect unit may include a plurality of filters corresponding to at least some modes of the special effect modes, and a driving apparatus for selecting the filters according to the special effect mode selected in advance, and positioning the filters on the light path of the viewfinder.

The control unit may process a special effect in an electrical signal of the photoelectric conversion device according to the mode of the special effect selected in advance.

According to another aspect of the present invention, there is provided a method of displaying an image of a viewfinder, the method including: setting a mode of a special effect; receiving the image light of an object through a lens unit; changing the path of the light passing through the lens unit so that the light is oriented in the direction of the viewfinder; and producing a special effect according to the set mode of the special effect in an image displayed on the viewfinder by the image light whose path is changed, for changing the image displayed on the viewfinder.

The producing of the special effect may be performed by driving a special effect unit disposed in the path of the light oriented in the viewfinder direction.

According to another aspect of the present invention, there is provided a method of photographing with a digital camera, the method including: setting a mode of a special effect; receiving the image light of an object through a lens unit; for viewfinder displaying, changing the path of the light passing through the lens unit so that the light is oriented in the direction of the viewfinder, and by driving a special effect unit disposed on the path of light oriented in the viewfinder direction according to the set mode of the special effect, changing the image displayed on the viewfinder; for photographing, converting the image formed by the image light passing through the lens unit, into an electrical signal; and for a special effect, processing a special effect in the electrical signal of the photoelectric conversion device according to the preset mode of the special effect.

According to the present invention as described above, the digital camera has a special effect unit and an optical viewfinder capable of converting an image light in the same manner as a special effect preset in the digital camera, and therefore when a user takes a photo by using a special effect photographing function, the user can confirm through the viewfinder an image of an object to be obtained through special effect processing, before the photo is taken.

### BRIEF DESCRIPTION OF THE DRAWINGS

The above and other features and advantages of the present invention will become more apparent by describing in detail exemplary embodiments thereof with reference to the attached drawings in which:

FIG. 1 is a side sectional view illustrating an internal structure of a digital camera according to an embodiment of the present invention;

FIG. 2 is a schematic side view illustrating elements of the digital camera illustrated in FIG. 1 according to an embodiment of the present invention;

FIG. 3 is a block diagram illustrating the relationship between a control unit and elements of the digital camera illustrated in FIG. 1 according to an embodiment of the present invention;

FIG. 4 is a flowchart illustrating a method of photographing with a digital camera according to an embodiment of the present invention;

FIG. 5 is a schematic side view illustrating elements of a digital camera according to another embodiment of the present invention;

FIG. 6 is a schematic side view illustrating elements of a digital camera according to another embodiment of the present invention;

FIG. 7 is a side view illustrating part of elements of a digital camera according to another embodiment of the present invention; and

FIG. 8 is a perspective view illustrating part of elements of a digital camera according to another embodiment of the present invention.

### DETAILED DESCRIPTION OF THE INVENTION

The present invention will now be described more fully with reference to the accompanying drawings, in which exemplary embodiments of the invention are shown.

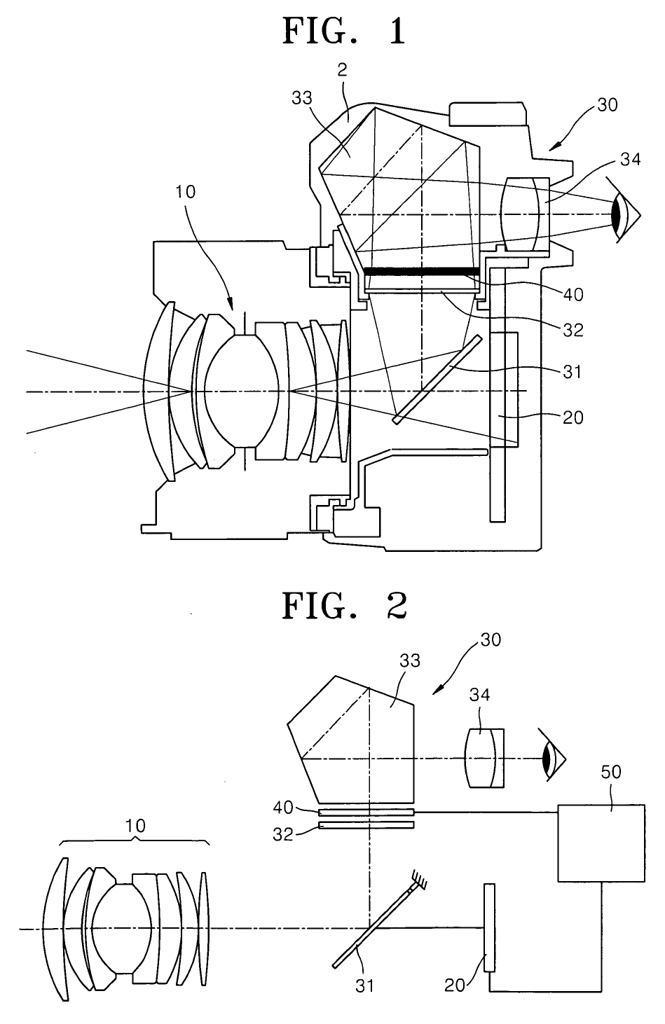

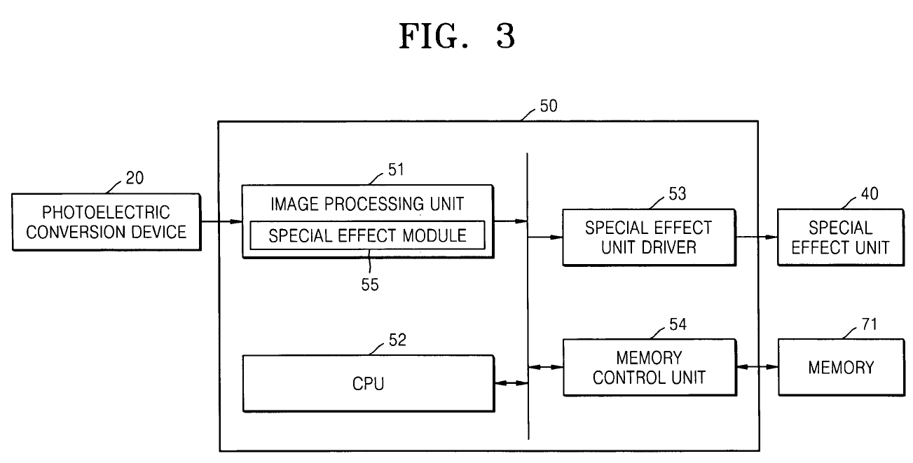

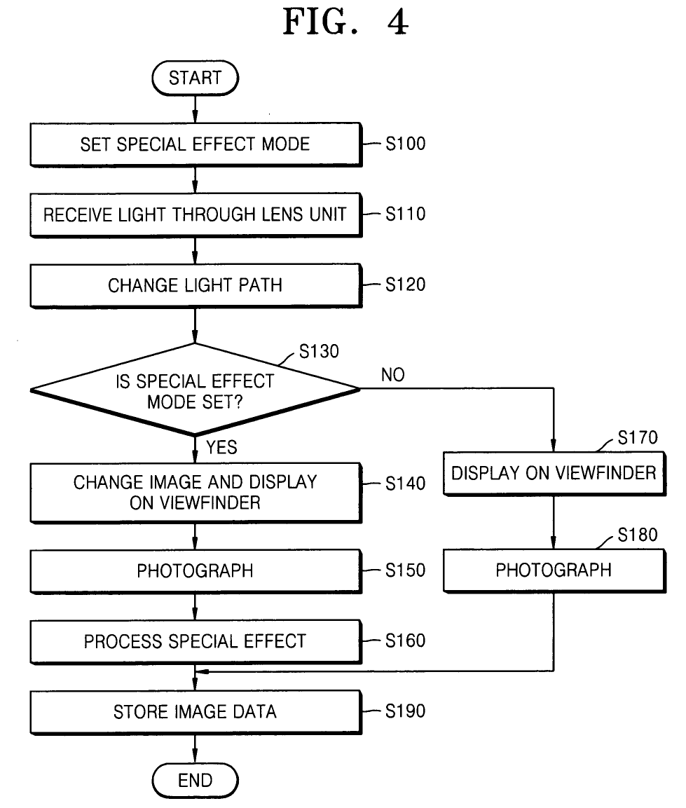

FIG. 1 is a side sectional view illustrating an internal structure of a digital camera according to an embodiment of the present invention, FIG. 2 is a schematic side view illustrating elements of the digital camera illustrated in FIG. 1 according to an embodiment of the present invention, and FIG. 3 is a block diagram illustrating the connection relationship between a control unit and elements of the digital camera illustrated in FIG. 1 according to an embodiment of the present invention.

Referring to FIGS. 1 and 2, the digital camera according to the current embodiment includes a lens unit 10 receiving the image light of an object and forming an image, a photoelectric conversion device 20 converting the image into an electrical signal, a viewfinder 30 enabling a user to observe the object, a special effect unit 40 producing a special effect on the image of the object displayed on the viewfinder, and a control unit 50 controlling the special effect unit 40.

The lens unit 10 disposed on the front part of a main body 2 of the digital camera receives the image light of the object and forms an image. The lens unit 10 includes a plurality of optical lenses.

The photoelectric conversion device 20 is disposed at a location where the image light passing through the lens unit 10 forms an image, and converts the image formed by the lens unit 10 into an electrical signal. Accordingly, the photoelectric conversion device 20 performs a central function of photographing in the digital camera. The photoelectric conversion device 20 is electrically connected to the control unit 50 and transmits signals to and receives signals from the control unit 50.

The viewfinder 30 changes the path of the light passing through the lens unit 10, thereby providing the light to the user so that the user can observe the object while taking a photograph.

The viewfinder 30 includes a mirror 31 which is disposed on the light path through which the image light travels and changes the path of the image light, a focus screen 32 adjusting the focus of the image light changed by the mirror 31, a prism 33 changing the path of the image light passing through the focus screen 32, and an eyepiece 34 receiving the image light emitted from the prism 33 and transferring the image light to the user.

The prism 33 illustrated in FIGS. 1 and 2 is a pentagonal prism and changes the direction of the image light passing through the focus screen 32 by about right angles, thereby orienting the image light in the direction of the eyepiece 34 disposed on the back surface of the main body 2 of the digital camera.

The special effect unit 40 is disposed in the path of light of the viewfinder 30 and produces a special effect on an image of an object displayed on the viewfinder 30. The digital camera has a function for producing a special effect and taking a photograph, the user selects a desired special effect according to his or her preference or a photographing situation, and takes a photograph, thereby obtaining an image which is processed with a desired special effect.

The special effect unit 40 changes an image of an object provided to the user through the viewfinder 30 according to the special effect preset in the digital camera by the user, thereby producing a special effect. Accordingly, by manipulating the shutter button, the user can view in advance through the viewfinder 30 how the image will be changed by the special effect preset in the digital camera, before a photograph is finally taken.

In the embodiment illustrated in FIGS. 1 and 2, the special effect unit 40 is disposed between the focus screen 32 and the prism 33 so that the special effect unit 40 may be adjacent to the focus screen 32. In the current embodiment, the special effect unit 40 is arranged between the focus screen 32 and the prism 33, but the present invention is not limited to this. Accordingly, the special effect unit 40 may also be disposed between the focus screen 32 and the mirror 31 so that the special effect unit 40 may be adjacent to the focus screen 32.

The special effect unit 40 allows the image light passing through the focus screen 32 from the mirror 31 to pass through, thereby transferring the image light to the prism 33. Being driven by the control unit 50, the special effect unit 40 can produce a special effect on an image of an object provided to the user through the viewfinder 30 according to the special effect mode selected. The special effect unit 40 can produce a special effect on an image to be displayed on the viewfinder 30, by changing one or more of the color, brightness, and saturation of the image to be displayed on the viewfinder 30. The special effect unit 40 may be a liquid crystal display (LCD) module. The special effect unit 40 may not have a separate light source and the image light of an object transferred through the lens unit 10 and the mirror 31 can be a light source. Alternatively, the special effect unit 40 may have the image light of an object as a major light source, and have an auxiliary light source (a backlight) generating light supporting the image light of the object.

The special effect unit 40 of the present invention is not limited to the LCD module, and a variety of devices can be used if the device allows light to pass through the device and at the same time the device can implement a desired color, brightness, or saturation being driven by the control unit 50. For example, the special effect unit 40 may be an organic electroluminescence device or light emitting diode (LED) display device, and the present invention is not limited to these types of devices.

As illustrated in FIG. 3, the control unit 50 embedded in the main body 2 is electrically connected to the photoelectric conversion device 20 and the special effect unit 40. In order to control operation of each element, the control unit 50 transmits a control signal to or receives a control signal from each of the elements, and processes data. The control unit 50 includes an image processing unit 51, a central processing unit (CPU) 52, a special effect unit driver 53, and a memory control unit 54.

The photoelectric conversion device 20 receives the image light of an object and generates an image signal which is an electrical signal. The image processing unit 51 of the control unit 50 converts the image signal input from the photoelectric conversion device 20 into image data indicating an image. The image data converted by the image processing unit 51 may be stored in the memory 71 through the memory control unit 54.

The image processing unit 51 includes a special effect module 55. The special effect module 55 allows the user to set, such as through a menu, a special effect in the digital camera, or produces a special effect in the image data according to a special effect mode which the digital camera automatically sets.

The special effects used in the digital camera may include a monochrome mode, a sepia mode, a user-specified mode, and a color reproduction mode with respect to light sources (fluorescent light, cloudy, sunlight, incandescent lamp). The special effect unit 40 is driven by the special effect unit driver 53 of the control unit 50, and changes an image thereby. In this way, the same effect as a special effect preset in the digital camera can be produced in an image displayed by the viewfinder 30.

As described above, the special effect unit 40 produces a special effect on an image of an object according to a selected special effect mode, and provides the image to the viewfinder 30. Accordingly, before a photograph is taken according to a special effect mode set in the digital camera and is processed in the special effect module 55, the user can view in advance an image obtained through processing of the same special effect, through the viewfinder 30.

FIG. 4 is a flowchart illustrating a method of photographing with a digital camera according to an embodiment of the present invention. FIG. 4 also illustrates a method of displaying an image on the viewfinder of the digital camera.

The method of photographing with a digital camera according to the current embodiment illustrated in FIG. 4 includes a mode setting operation S100 for setting a mode of a special effect, a light receiving operation S110 for receiving the image light of an object through a lens unit, a light path changing operation S120 for changing the path of light to the viewfinder, an image changing operation S140 for producing a special effect on an image displayed on the viewfinder according to a preset special effect mode, a photographing operation S150 for converting an image into an electrical signal by a photoelectric conversion device, a special effect operation S160 for processing a special effect in the electrical signal of the photoelectric conversion device according to a preset special effect mode.

In the mode setting operation S100, a special effect mode is set in the digital camera in order to perform special effect photographing. In the mode setting operation S100, a special effect mode such as a monochrome mode, a sepia mode, a user-specified mode, and a color reproduction mode with respect to light sources (fluorescent light, cloudy, sunlight, incandescent lamp) is set. The user may select and set a special effect mode by manipulating the menu of the digital camera, or when necessary, the digital camera may automatically recognize a photographing environment and set an appropriate mode.

In the light receiving operation S110, the image light of an object is received through a lens unit to the inside of the main body of the digital camera. The lens unit can form an image by receiving the image light of the object. The image light incident on the digital camera through the lens unit forms an image on the photoelectric conversion device of the digital camera or can be provided to the viewfinder.

In the light path changing operation S120, the path of the image light passing through the lens unit is changed so that the image light is oriented in the direction of the viewfinder.

Depending on whether or not a special effect mode is set, as determined in operation S130, the control unit may perform image displaying on the viewfinder and photographing in a different manner. If a special effect mode is set in the mode setting operation S100, the control unit may perform the image changing operation and viewfinder displaying operation S140 and the special effect operation S160.

In the image changing operation and viewfinder displaying operation S140, a special effect is produced in an image displayed on the viewfinder according to the special effect mode set in the mode setting operation S100.

The image changing operation can be performed by a special effect unit disposed on the path of light oriented in the viewfinder direction. If a special effect mode is set in the mode setting operation S100, the control unit drives a special effect module disposed on the path of light oriented in the viewfinder direction, thereby producing a special effect in an image displayed on the viewfinder. The special effect unit can produce a special effect, by changing one or more of the color, brightness, and saturation of the image to be displayed on the viewfinder.

The special effect unit changes an image of an object provided to the user through the viewfinder according to a special effect preset in the digital camera. Being driven by the control unit, the special effect unit changes one or more of the color, brightness, and saturation of the image, thereby producing the special effect in the image displayed on the viewfinder as the special effect preset in the digital camera. Accordingly, the user can view in advance through the viewfinder how the image will be changed by a special effect preset in the digital camera, before a photo is finally taken by manipulating a shutter button.

The special effect unit may be an LCD module. When the special effect unit is implemented by an LCD module, a separate light source need not be disposed, and the image light of an object transferred through the lens unit and mirror can be a light source. Also, the special effect unit may be, for example, an organic electroluminescence device or LED display device.

The photographing operation S150 can be performed when the user operates the shutter button of the digital camera or by an automatic operation of the digital camera. In the photographing operation S160, the image formed by the image light passing through the lens unit is converted into an electrical signal by the photoelectric conversion device.

After the photographing operation S160, the special effect operation S160 can be performed. In the special effect operation S160, processing of a special effect in the electrical signal of the photoelectric conversion device is performed according to a preset special effect mode.

As described above, the special effect unit changes the image of the object according to a preset special effect mode, and provides the image to the viewfinder. Accordingly, before a photo is taken according to a special effect mode set in the digital camera and is processed in the special effect module, the user can view in advance an image obtained through processing of the same special effect as will be produced in a photo image to be taken, through the viewfinder.

The image data obtained by processing the special effect in the electrical signal of the photoelectric conversion unit in the special effect operation S160 can be stored in a memory of the digital camera.

If a special mode effect is not set in the mode setting operation S100, as determined in operation S130, the control unit omits the image changing operation and special effect operation, and can perform the viewfinder displaying operation S170 and the photographing operation S180.

In the viewfinder displaying operation S170, processing of a special effect in the light oriented in the direction of the viewfinder is not performed, and an image of the object having natural colors without change is provided to the viewfinder.

Also, after the photographing operation S180, processing of a special effect in the electrical signal of the photoelectric conversion device is not performed, and the electrical signal generated by photographing is directly converted into image data and can be stored in the memory of the digital camera in operation S190.

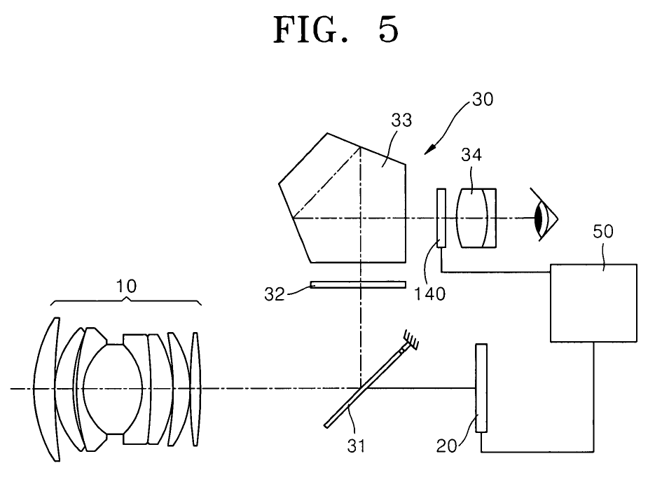

FIG. 5 is a schematic side view illustrating elements of a digital camera according to another embodiment of the present invention.

The digital camera according to the current embodiment illustrated in FIG. 5 includes a lens unit 10 receiving the image light of an object and forming an image, a photoelectric conversion device 20 converting the formed image into an electrical signal, a viewfinder 30 changing the path of the light passing through the lens unit 10 SO that a user can observe the object, a special effect unit 140 disposed on the path of light of the viewfinder 30 and changing the image of the object, and a control unit 50 controlling the special effect unit 140. The same reference numbers are used for the same elements as illustrated in FIGS. 1 and 2.

The special effect unit 140 is disposed on the path of light of the viewfinder 30, but the position at which the special effect unit 140 is changed from that illustrated in FIGS. 1 and 2. The special effect unit 140 is disposed so as to be adjacent to the eyepiece 34.

The path of the image light incident on the lens unit 10 is changed by the mirror 31, and through the focus screen 32 and the prism 33, the image of the object is provided to the user through the eyepiece 34.

The special effect unit 140 is connected to the control unit 50, and is driven by the control unit 50 according to a special effect mode selected in advance in the digital camera, thereby producing a special effect in the image by the image light passing through the prism 33. Accordingly, before a photo is taken by manipulating a shutter button, the user can view in advance through the viewfinder how an image will be changed by the special effect set in the digital camera.

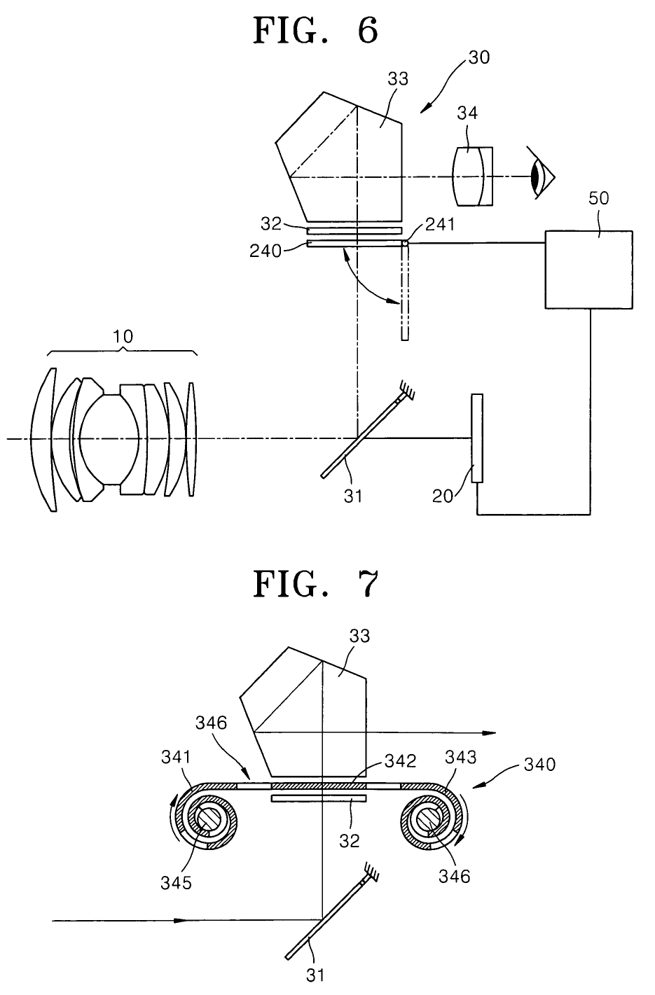

FIG. 6 is a schematic side view illustrating elements of a digital camera according to another embodiment of the present invention.

The digital camera according to the current embodiment illustrated in FIG. 6 includes a lens unit 10 receiving the image light of an object and forming an image, a photoelectric conversion device 20 converting the formed image into an electrical signal, a viewfinder 30 changing the path of the light passing through the lens unit 10 so that a user can observe the object, a special effect unit 240 disposed on the path of light of the viewfinder 30 and changing the image of the object, and a control unit 50 controlling the special effect unit 240. The same reference numbers are used for the same elements as illustrated in the embodiments described above.

The special effect unit 240 is disposed on the path of light of the viewfinder 30, but the position at which the special effect unit 140 is changed from that illustrated in the embodiments described above. The special effect unit 140 is disposed between the mirror 31 and the focus screen 32 so as to be adjacent to the focus screen 32.

The special effect unit 240 is coupled with the main body of the digital camera through a rotation axis 241 so that the special effect unit 240 can rotate. Also, the rotation axis 241 is driven by a driving motor (not shown) driven by a control signal from the control unit 50. Accordingly, the special effect unit 240 can rotate about the rotation axis 241, thereby being switched between an active position (indicated by a solid line in the drawing) in which it is positioned in the path of light of the viewfinder, and an inactive position (indicated by a dotted line in the drawing) in which it is not positioned in the path of light of the viewfinder.

Accordingly, when the digital camera is set to a special effect photographing function, the control unit 50 drives the rotation axis 241 of the special effect unit 240 so that the special effect unit 240 is switched to the active position. Then, the control unit 50 controls the special effect unit 240 according to a special effect mode preset in the digital camera, thereby processing the same special effect in the image of the viewfinder 30.

When the special effect photographing function of the digital camera is not set, the control unit 50 drives the rotation axis 241 of the special effect unit 240 so that the special effect unit 240 is switched to the inactive position. Since the image light of the viewfinder is transferred to the user in the original state, the user can watch the image in the natural state without special effect processing.

FIG. 7 is a side view illustrating part of elements of a digital camera according to another embodiment of the present invention.

The digital camera according to the current embodiment illustrated in FIG. 7 has a special effect unit 340 with a modified feature. The special effect unit 340 has a plurality of filters 341, 342, and 343, and a rotation axis 345 which is a driving apparatus for positioning the filters 341, 342, and 343 on the path of light of the viewfinder.

The filters 341, 342, and 343 change the color of the image light according to special effect modules of the digital camera. In the current embodiment, the filters 341, 342, and 343 are provided as a film 346 in the form of a roll that can be rolled about the axes 345 and 346 or unrolled. The rotation axes 345 and 346 can rotate being connected to a driving motor (not shown). Accordingly, if the driving motor is driven by the control unit, the rotation axes 345 and 346 rotate, thereby selectively positioning any one of the filters 341, 342, and 343 on the path of light of the viewfinder.

The control unit controls the rotation of the rotation axes 345 and 346, thereby accurately controlling the positions of the filters 341, 342, and 343 arranged on the path of light of the viewfinder. In this way, the filters 341, 342, and 343 corresponding to special effect modes set in the digital camera can be selected.

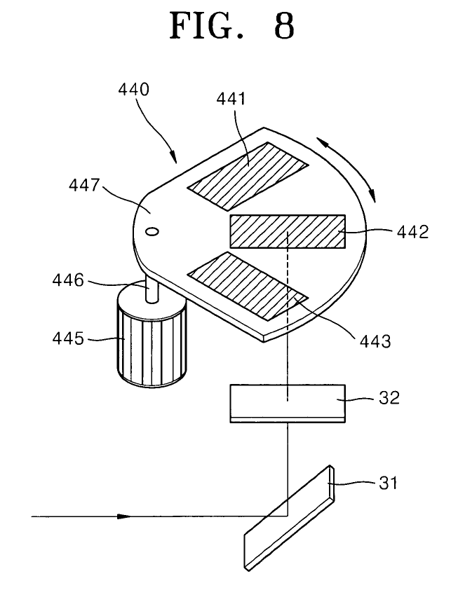

FIG. 8 is a perspective view illustrating part of elements of a digital camera according to an embodiment of the present invention.

The digital camera according to the current embodiment illustrated in FIG. 8 has a special effect unit 440 with a modified feature. The special effect unit 440 has a plurality of filters 441, 442, and 443, and a driving apparatus for positioning the filters 441, 442 and 443 on the path of light of the viewfinder.

The driving apparatus of the special effect unit 440 includes a driving motor 445, and a rotation plate 447 coupled with the rotation axis 446 of the driving motor 445. The filters 441, 442 and 443 are arranged on the rotation plate 447. If the driving motor 445 is driven by the control unit, the rotation plate 447 rotates, thereby positioning any one of the filters 441, 442 and 443 on the path of light of the viewfinder.

FIG. 8 illustrates that the path of light of the viewfinder is changed by a mirror 31, and the light penetrates the filter 443 through the focus screen 32. The control unit controls the rotation position of the rotation plate 447 by driving the driving motor 445, thereby accurately controlling the rotation positions of the filters 441, 442 and 443 disposed on the path of light of the viewfinder. In this way, the filters 441, 442 and 443 corresponding to the special effect modes set in the digital camera can be selected.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A digital camera comprising:
a lens unit receiving the image light of an object and forming an image;
a photoelectric conversion device converting the formed image into an electrical signal;
a viewfinder receiving the light passing through the lens unit;
a special effect unit disposed in the path of light between the lens unit and the viewfinder and producing a special effect on an image to be displayed on the viewfinder; and
a control unit connected to the photoelectric conversion device and the special effect unit and driving the special effect unit according to a selected special effect mode.

2. The digital camera of claim 1, wherein the special effect unit changes at least one of the color, brightness, and saturation of the image to be displayed on the viewfinder.

3. The digital camera of claim 1, wherein the viewfinder comprises:
a mirror disposed in the light path of the lens unit and which changes the path of the image light;
a focus screen adjusting the focus of the image light changed by the mirror;
a prism changing the path of the image light passing through the focus screen; and
an eyepiece receiving the image light emitted from the prism and transferring the image light to a user.

4. The digital camera of claim 3, wherein the special effect unit is disposed so as to be adjacent to the focus screen.

5. The digital camera of claim 3, wherein the special effect unit is disposed so as to be adjacent to the eyepiece.

6. The digital camera of claim 1, wherein the special effect unit can be switched between an active position disposed in the light path between the lens unit and the viewfinder and an inactive position not disposed in the light path according to a signal of the control unit.

7. The digital camera of claim 1, wherein the special effect unit is a unit selected from the group consisting of a liquid crystal display (LCD) module, an organic electroluminescence device, and a light emitting diode (LED) display device.

8. The digital camera of claim 1, wherein the special effect unit comprises a plurality of filters corresponding to at least two special effect modes, and a driving apparatus for selecting a filter according to a selected special effect mode and positioning the filter in the light path of the viewfinder.

9. The digital camera of claim 1, wherein the control unit processes a special effect in an electrical signal of the photoelectric conversion device according to a selected special effect mode.

10. A method of displaying an image in a viewfinder, the method comprising:
setting a special effect mode;
receiving the image light of an object through a lens unit;
changing the path of the light passing through the lens unit so that the light is oriented in the direction of the viewfinder; and
producing a special effect according to the set special effect mode on the image light displayed on the viewfinder.

11. The method of claim 10, wherein the producing of the special effect is performed by driving a special effect unit disposed on the path of the light oriented in the viewfinder direction.

12. The method of claim 11, wherein the special effect unit changes at least one of the color, brightness, and saturation of the image.

13. The method of claim 11, wherein the special effect unit is a unit selected from the group consisting of a liquid crystal display (LCD) module, an organic electroluminescence device, and a light emitting diode (LED) display device.

14. A method of photographing with a digital camera, the method comprising:
setting a special effect mode;
receiving the image light of an object through a lens unit;
for viewfinder displaying, changing the path of the light passing through the lens unit so that the light is oriented in the direction of the viewfinder, and by driving a special effect unit disposed on the path of light oriented in the viewfinder direction according to the set special effect mode, changing the image displayed on the viewfinder;
for photographing, converting the image formed by the image light passing through the lens unit, into an electrical signal; and
for a special effect, processing a special effect in the converted electrical signal according to the set special effect mode.

15. The method of claim 14, wherein the special effect unit changes at least one of the color, brightness, and saturation of the image displayed on the viewfinder.
